(19) United States
(12) Patent Application Publication
(10) Pub. No.: US 2001/0042632 A1
(43) Pub. Date: Nov. 22, 2001

(54) Filter for wire and cable

(75) Inventors: Vladimir Manov, Even Yehuda (IL); Alexandru Antonenco, Even Yehuda (IL); Alexander Exelrod, Even Yehuda (IL); Alexander Rubshtein, Even Yehuda (IL); Evgeni Sorkine, Even Yehuda (IL)

Correspondence Address: DR. MARK FRIEDMAN LTD., c/o ANTHONY CASTORINA, SUITE 207, 2001 JEFFERSON DAVIS HIGHWAY, ARLINGTON, VA, 22202, US

(73) Assignee: ADVANCED FILTERING SYSTEM LTD

(21) Appl. No.: 09/859,430

(22) Filed: May 18, 2001

(30) Foreign Application Priority Data
Oct. 27, 1999 (IL) PCT/IL99/00567
Nov. 19, 1998 (IL) 127140

(51) Int. Cl. H01B 7/29

(52) U.S. Cl. 174/36

(57) ABSTRACT

A filter for wires and cables comprising at least one pair of inner conductive wires made of an electrically conductive metal covered with an outer layer of magnetic absorbing material. This outer layer is formed from glass-coated microwires containing soft ferromagnetic amorphous material, preferably wound about the conductive wires to form a thin ferromagnetic layer. The filter may include two or more pairs of inner conductors with the ferromagnetic outer layers implemented separately or as a single common outer layer. The inner pairs of conductors may be either straight or twisted.

### TECHNICAL FIELD

This invention concern filters for wires and cables for use in electronics. The invention relates in particular to such filters which include layers of absorbing magnetic material comprising glass-coated microwires and amorphous metal tape.

### BACKGROUND ART

Prior art methods for reducing noise in electronic systems include shielding of cables and filtering.

Modern electronic systems have to meet stringent requirements for Electromagnetic Compatibility (EMC). Electronic systems may generate electromagnetic noise during their operation. This noise may interfere with other systems. EMC standards and regulations for electronic equipment have been set up in many countries. These standards define a maximum level of noise that may be generated by electronic equipment, and the sensitivity of electronic equipment to noise generated by others.

In many cases, ambient electromagnetic noise penetrates the electronic equipment through the electrical cables. In system comprising several parts, noise or interference may be transferred from one part to the other, or the cable itself may act as an antenna to receive interfering signals, that penetrate the electronic system.

Moreover, signals transmitted through a cable may be transmitted to other cables in that system or to other systems, thus creating an additional noise or interference.

Noise or interference reduction in electronic systems may be achieved using shielding of cables and filtering.

U.S. Pat. No. 4,868,565 discloses shielded cables wherein a shield is made of copper strands and/or metal foil strips. Such cables may be used for transferring signals between electronic units, while achieving a reduction of undesirable electromagnetic radiation coming from the environment. The efficiency of such cables, however, may not be sufficient where noise protection is required between parts of a system that are connected by cables. For example, if noise is generated in one part of an electronic equipment, the cable may transfer that noise to another part of the equipment by an electrical conduction mechanism.

U.S. Pat. No. 4,301,428 of Nov. 17, 1981 disclosed RFI suppressor cable having resistive conductor and lossy magnetic absorbing material in general terms, using it as anti-parasitic cables for ignition of internal combustion engines, instrumentation and low-pass cables, co-axial cables, shields and screens.

To reduce the noise transferred by conduction, methods known in the art include additional filtering. One known method includes the mounting of ferrite rings onto the cable. US Pat. No. 4,992,060 details such a method and apparatus for the reduction of radio-frequency noise. The disclosed apparatus includes ferrite core that is mounted inside a connector plug to surround all the connectors of a transmission line interconnecting device. The ferrite core functions to provide a substantially increased series impedance in the conductors, thus reducing high frequency noise that would otherwise be transferred by conduction.

Another means for noise reduction includes EMI filters. These filters may be divided into two categories: Reactive filters and absorptive filters. Filters composed of capacitors and inductors ( L-C filters) are an example of a reactive filter. Ferrite beads or lossy wires operate as absorptive low-pass filters.

Attenuation in L-C filters is a result of impedance mismatch between the source and the filter input on one side, and between the filter output and the load. A large attenuation is achieved because of energy reflections because of impedance mismatch conditions, at both the source and load ports of the filter. The effectiveness of L-C EMI filters largely depends on the values of source and load impedance. Capacitive filters have good attenuation properties when both the source and load impedance are high. Series inductor filters are more efficient where both the source and load impedance are low.

To achieve good performance in other cases of source and load impedance combinations, more complex filter structures are required, having, for example, more poles in the frequency domain. EMI filters have to operate in circuits having a wide range of source and load impedance. Moreover, in many cases the values of the impedance is not known, so the selection of an effective filter type may be difficult. To address various impedance values, complex filters are used. A useful EMI filter uses a combination of series inductors and filter capacitors between the filtered line and chassis.

In other cases where capacitors cannot be connected to chassis (for example where the housing is made of a non-conductive material), filtering of high-impedance EMI noise may be difficult.

Absorptive filters operate on the principle of energy absorption in a lossy medium surrounding the cable. Noise and interference filtering is achieved due to the fact that energy absorption is low at low frequencies (the frequency band occupied by a desired signal) and high at higher frequencies (the band occupied by interference signals).

Power loss in a magnetic material increases with the magnetic field. Thus, the higher amplitude noise currents will result in larger magnetic fields in the lossy material, and will be attenuated. The lossy effect is expected to be larger for lower source and load impedance, where the current is larger.

The impedance of ferrite beads and Common-Mode Chokes (CMC) based on ferrite core materials demonstrate a complex behavior, being partly inductive and partly dissipative. Thus, ferrite beads and CMCs also operate partly as absorptive filters.

A significant difference between ferrite beads and lossy wires is that lossy wires operate as a distributed component, whereas ferrite beads and CMCs are lumped components.

Distributed lossy wires should preferably be long enough to achieve sufficient attenuation over a wide range of frequencies. For lower frequencies, the wavelength is longer so the distributed filter will envelope a large part of the cable. In general, a complete cable may be manufactured of lossy wire. Commercially available lossy wires and cables are coated with a thin layer of plastic including a ferrite powder, or carbon coating may be used on surface of metallic wire used in the cable. This method and structure cannot achieve good enough attenuation at low frequencies, since known ferrite-coating materials can only contain a low percentage of ferrite particles. A higher percentage of ferrite particles would result in rigidity of the cables. The distance between ferrite particles in the lossy layer is rather large, with the resulting demagnetization factor providing for an additional decrease in the effective permeability.

In many applications, the attenuation achieved with presently available lossy wires is not sufficient. Due to low ferrite concentration in composite materials used for lossy wires, these wires do not achieve a sufficient attenuation at the lower frequency band. Sufficiently high energy losses are usually achieved only at frequencies above 200 MHz.

Attenuation could be increased using a thick layer of ferrite, however, this would make the wire rigid rather than flexible.

It is an objective of the present invention to provide for a discrete filter component, or a filter wire and cable with means for overcoming the above detailed deficiencies.

### DISCLOSURE OF INVENTION

It is an object of the present invention to provide filter for wires and cables with a microwire energy absorbing layer higher attenuation values at lower frequencies as compared with existing magnetic lossy materials.

According to one aspect of the present invention, the energy absorbing layer uses a glass coated microwire, with the microwire made of a soft ferromagnetic metallic alloy.

According to a second aspect of the present invention, the energy absorbing layer is made with the microwire being wound around the cable to form a relatively thin ferromagnetic layer.

According to a third aspect of the invention, a lossy cable includes a layer of lossy ferromagnetic microwires, an electrically conductive shielding layer and insulation layers.

According to another aspect of the invention, the microwire layer may be used in a multi-wire cable or twisted pair cables or flat cables to achieve good EMI protection therefor.

The microwire windings provide a ferromagnetic layer having a higher permeability, which achieves a higher attenuation per unit length of cable.

The soft ferromagnetic material in the microwire may be either an amorphous alloy or a nano-crystalline alloy or a micro-crystalline alloy or a combination thereof. For the purpose of the description and claims, all of these possibilities will be referred to generically as “amorphous materials”.

The microwire-coated wire is flexible, because of the very small diameter and therefore high flexibility of the microwires.

Further objects, advantages and other features of the present invention will become obvious to those skilled in the art upon reading the disclosure set forth hereinafter.

### BRIEF DESCRIPTION OF THE DRAWINGS

FIG. 1A illustrates a side view of a microwire, and with FIG. 1B illustrates a cross-sectional view of the microwire.

FIG. 2 illustrates the magnetic hysteresis characteristic of the microwire.

FIGS. 3A and 3B illustrate the permeability of a microwire as a function of frequency, with FIGS. 3A and 3B detailing the two components (real and imaginary) of the microwire permeability.

FIG. 4 details the structure of a lossy cable.

FIG. 5 details the attenuation in the cable as a function of frequency.

FIG. 6 details the structure of a cable with a twisted pair.

FIG. 7 illustrates the structure of a cable with one embodiment of the microwire layer.

FIG. 8 illustrates the structure of a cable with another embodiment of the microwire layer.

FIG. 9 details the attenuation in a cable as a function of frequency.

### MODES FOR CARRYING OUT THE INVENTION

A preferred embodiment of the present invention will now be described by way of example and with reference to the accompanying drawings.

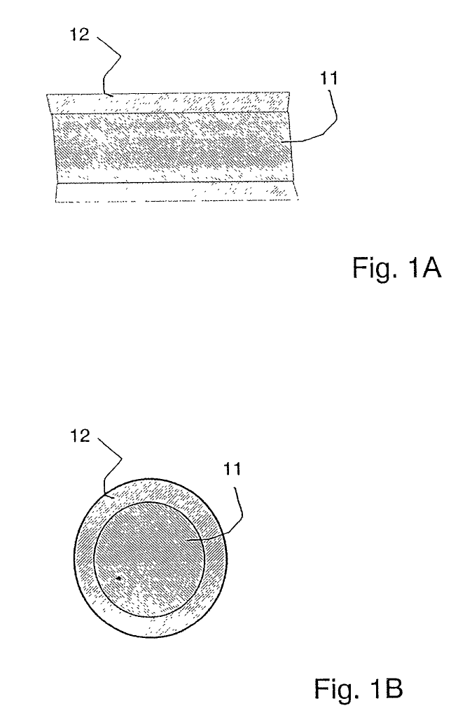

FIG. 1A illustrates a side view of a microwire, and with FIG. 1B illustrates a cross-sectional view of the microwire.

Thus, the microwire has a metallic core 11 and a glass coating 12. Microwires as illustrated are known in the art. British Patent No. 1, 120, 247 and U.S. Pat. No. 5,240,066 details a method for manufacturing microwires.

Until now, however, these microwires were not used to form EMI noise filters to protect signals transmitted along cables or wires.

In order to provide sufficient energy absorbing properties while ensuring sufficient flexibility to allow winding to form a continuous absorbing layer, a specific range of microwire dimensions is preferred, specifically, the diameter of the microwire core 11 is preferably in the range of about 6-8 microns, while the thickness of the glass coating 12 is preferably about 2-3 microns. Thus, the overall microwire diameter is preferably in the range of about 10-14 microns.

To be usable for coating conductive wires with an energy-absorbing layer according to the present disclosure, core 11 may be made of an amorphous alloy or a nano-crystalline alloy or a micro-crystalline alloy. In other embodiments of the present invention, a combination of the above alloys may be used.

In a preferred embodiment, core 11 is made of a (CoMe)Bsi alloy, where Me is a metal or combination of metals from a set of Fe, Mn, Ni and Cr.

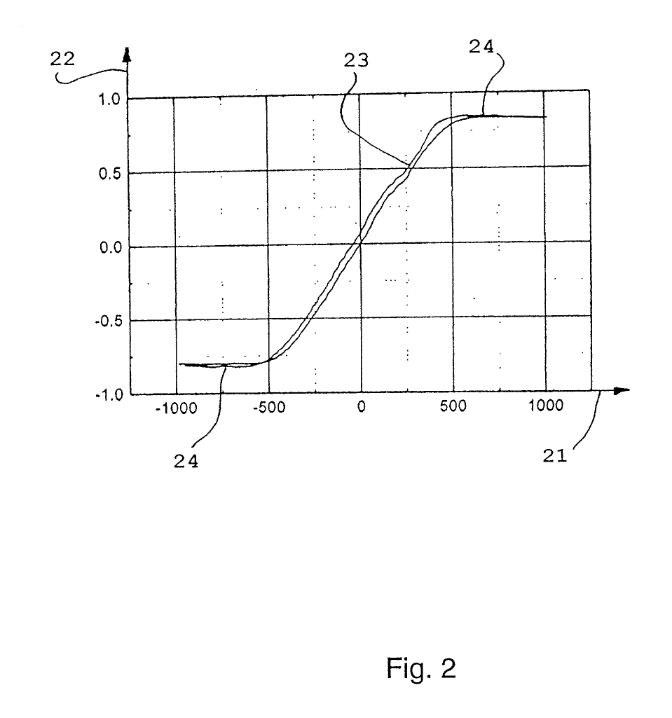

FIG. 2 illustrates the magnetic hysteresis characteristic of the microwire, which has “flat” shape. Thus, the microwires magnetization is illustrated as a function of the magnetic field intensity, with magnetic field intensity axis 21 (A/m) and magnetization axis 22 (Tesla). This is the magnetic flux density exhibiting a linear region 23 and a saturation region 24 for higher values of the magnetic field.

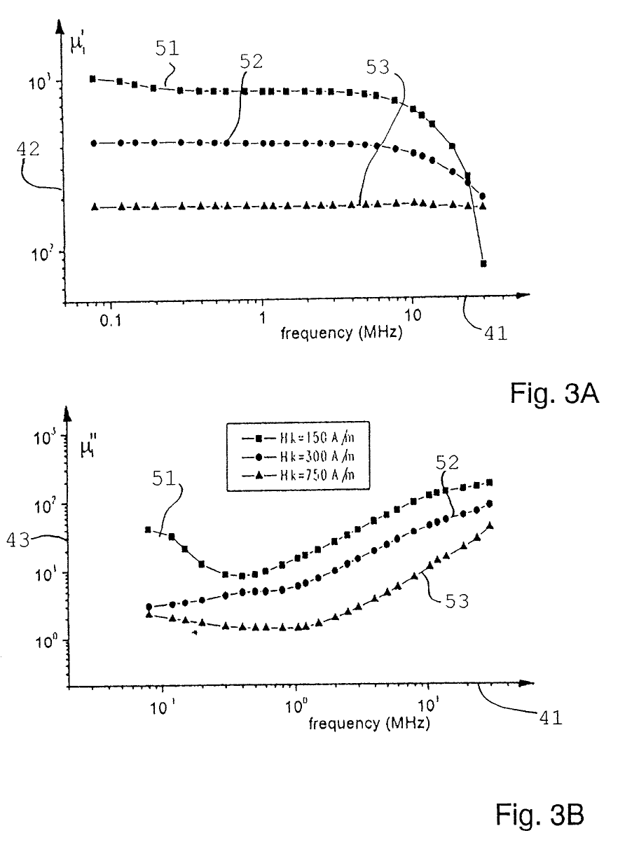

FIGS. 3A and 3B illustrate the relative permeability of a microwire as a function of frequency. FIG. 3A details the real component 42 of the permeability in a complex space, versus frequency 41.

FIG. 3B details the imaginary component 43 of the permeability in a complex space, versus frequency 41.

Together, FIGS. 3A and 3B detail the magnitude and phase of the relative permeability of a microwire as a function of frequency.

The graphs detail the relative permeability with the magnetic anisotropy as parameter, for three values of that parameter:

Graphs 51 indicate permeability for a magnetic anisotropy of 150 A/m;

Graphs 52 indicate permeability for a magnetic anisotropy of 300 A/m;

Graphs 53 indicate permeability for a magnetic anisotropy of 750 A/m.

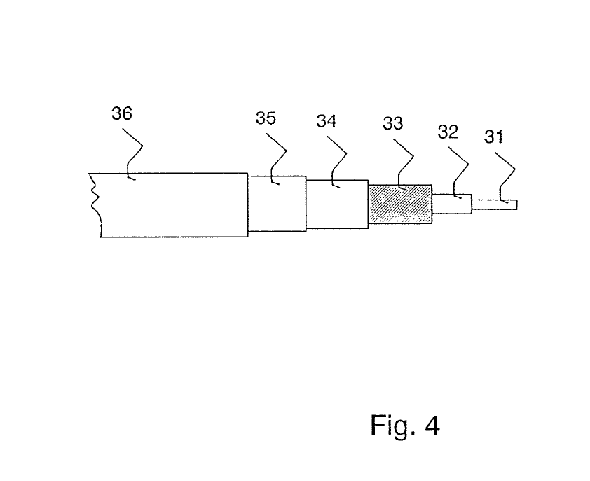

FIG. 4 details one embodiment of a lossy filtered cable element. The filter structure includes a central conductor(s) 31 (the signal-carrying wires) with a thin insulation layer 32 to provide electrical insulation, and a layer of glass-coated microwire 33, wound on layer 32 to form a thin magnetic layer thereon. Thus, the energy absorbing layer 33 uses a glass coated microwire, with the microwire made of a soft ferromagnetic amorphous metallic alloy.

It is important that the microwire be wound around the signal carrying wires in a direction perpendicular to the extensional direction of the signal carrying wires. This is achieved by forming a close-packed cylindrical winding in which each loop approximates to a circle around the signal carrying wires. The absorptive layer is preferably formed by a plurality of layers of winding (preferably between 2 and 10 layers) wound one on top of the other to form a soft magnetic layer of overall thickness about 20-100 microns.

Layer 33 is used for absorbing the EMI energy as desired, to achieve a lossy cable affect. Layer 33 is deposited over a minimum sizable part of the conductors 31, still achieving distributed lossy properties of good attenuation from low frequencies (starting with several MHz) through to high frequencies.

The soft ferromagnetic material in the microwire may be either an amorphous alloy or a nano-crystalline alloy or a micro-crystalline alloy or a combination thereof.

The filter structure further includes a second thin insulator layer 34, an electrical shield 35 (for example a copper wire braid) and an option for outer protection/insulator layer 36.

Experimental results indicate that a better attenuation of the present invention is achieved at low frequencies with the novel microwire-coated filter, with respect to existing lossy cables. The invention continues to provide superior attenuation properties throughout a very wide frequency range through high frequencies (1 GHz and above). Attenuation measurement results versus frequency are indicated in Table 1, for a microwire-coated filter as well as for existing cables.

TABLE 1

| | Attenuation, dB/ft | | | | |
|---|---|---|---|---|---|
| | Microwire | Lossy wire | | | |
| Frequency | coated | per MIL-C- | | | |
| MHz | filter | 85485 | Vendor #1 | Vendor #2 | Vendor #3 |
| 10 | 4.0 | 0.04-0.1 | 0 | 0.1 | 0 |
| 20 | 6.4 | | 0 | 0.3 | 0 |
| 30 | 7.4 | | 0 | 1.0 | 0 |
| 40 | 7.9 | | 0 | | 0 |
| 50 | 8.2 | | 0 | 1.7 | 1.0 |
| 60 | 8.7 | | 0.2 | | 1.6 |
| 70 | 9.1 | | 0.4 | | 2.4 |
| 80 | 9.5 | | 0.4 | | 4.0 |
| 90 | 10.0 | | 0.3 | | 4.4 |
| 100 | 10.6 | 1.3 | 0.4 | 4.2 | 4.0 |
| 120 | 12.4 | | 0.5 | | 4.0 |
| 140 | 14.2 | | 1.0 | | 6.0 |
| 160 | 15.0 | | 0.5 | | 8.0 |
| 180 | 16.2 | | 1.0 | | 8.8 |
| 200 | 18.0 | | 2.0 | 7.7 | 12.4 |
| 250 | 20.4 | | 2.4 | | 12.0 |
| 300 | 23.5 | | 2.9 | 10.7 | 8.0 |
| 350 | 27.0 | | 4.4 | | 8.0 |
| 400 | 32.2 | | 6.0 | 12.3 | 8.0 |
| 450 | 35.8 | | 7.1 | | 8.0 |
| 500 | 40.0 | 1.3 | 8.0 | 14.3 | 8.0 |
| 550 | 45.0 | | 9.8 | | 8.0 |
| 600 | 50.0 | | 11.4 | 16 | 8.0 |
| 650 | 47.0 | | 12.5 | | 8.0 |
| 700 | 43.0 | | 13.4 | 17.3 | 8.0 |
| 750 | 46.0 | | 15.3 | | 8.0 |
| 800 | 44.0 | | 17.0 | | 8.0 |
| 850 | 42.0 | | 19.2 | | 9.0 |
| 900 | 41.0 | | 21.0 | | 14.0 |
| 950 | 38.0 | | 23.0 | | 15.0 |
| 1000 | 38.0 | 12 | 24.0 | | 16.0 |

Thus, it appears that the new microwire-coated filter may be suitable for solving EMI-related problems at frequencies above about 10 MHz, and is most effective at frequencies above about 30 MHz. Thus, better EMI performance is achieved with respect to existing lossy cables.

The microwire windings achieve a ferromagnetic layer having a higher permeability, which achieves a higher attenuation per unit length of cable. The length-to-diameter ratio is very large for microwires, therefore the effect of demagnetization is negligible. For example, in a typical microwire the amorphous core diameter is about 10 microns, whereas the wire length may be about 1 km.

Good attenuation in the lossy filtered cable based on a microwire layer is achieved in the wide frequency range wherein the microwire has very good attenuation properties. Apparently the microwires form a magnetic layer that, through re-magnetization, absorbs interference energy in a wide frequency range.

Moreover, the microwire-coated conductive wires are flexible, because of the very high flexibility of the microwires.

The outer isolation 36 is optional, to be used in applications where a loose cable may cause a short circuit. In other cases, the outer coating 36 may not be necessary.

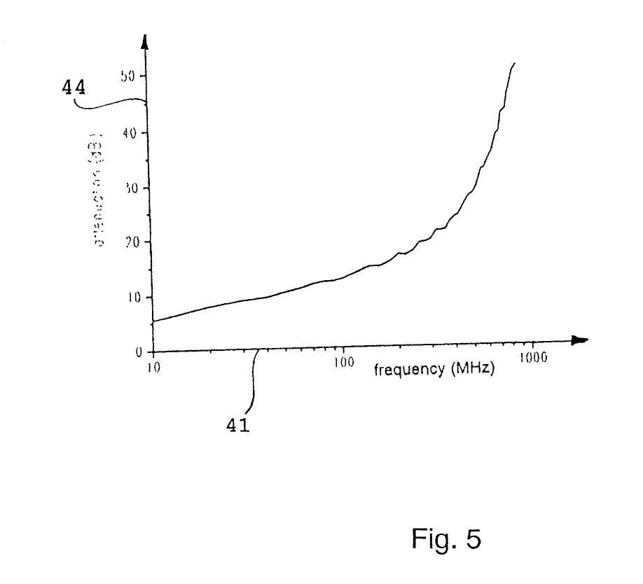

FIG. 5 details the attenuation in a microwire-coated filter as a function of frequency, as illustrated in a graph with an attenuation axis 44 vs. a frequency axis 41. It refers to a filter with a microwire layer as detailed with reference to FIG. 4. The graph indicates the experimental results for a lossy filtered cable that has an 1.0 gram of microwire coating layer distributed thereon. This structure achieves about 9 dB attenuation at 30 MHz, and about 40 dB attenuation at 300 MHz.

It is evident that a microwire-coated filter may be used in applications where a significant attenuation is required above 30 MHz. Thus, wires and cables with a microwire energy absorbing filter achieve higher attenuation values at lower frequencies with respect to existing lossy cables.

From an attenuation effectiveness point of view, when comparing microwire-based filters with existing lossy wires, cables with a microwires filter have significantly better performance in the 30-300 MHz frequency range. A large part of the EMI radiated emission and radiated susceptibility problems falls into this frequency band.

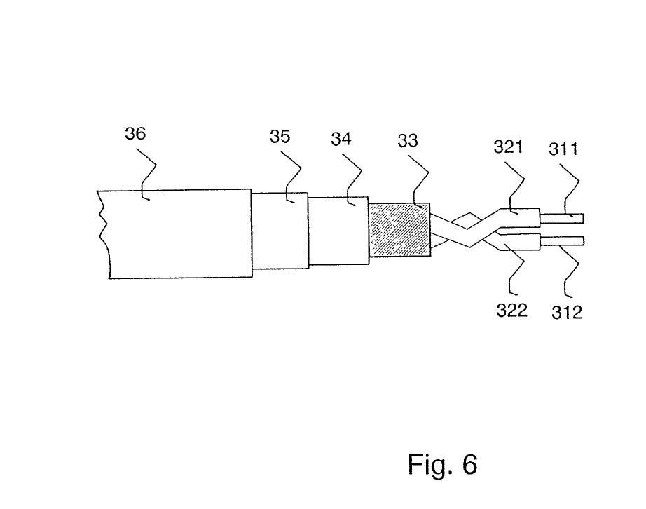

FIG. 6 details the structure of a cable element with a twisted pair comprising a central pair of conductors 311, 312, each with its separate thin insulation layer 321, 322 respectively. A common layer of glass coated microwire 33 is wound on the insulated conducted pair as illustrated. The layer 33 may be coated with a thin insulator layer 34.

The cable element also includes an electrical shield layer 35, made for example of a copper wire braid.

The cable may also have an outer protective/insulator layer 36. Thus, the microwire layer 33 may be used in a multi-wire cable or twisted pair cables or flat cables to achieve good EMI protection therefor.

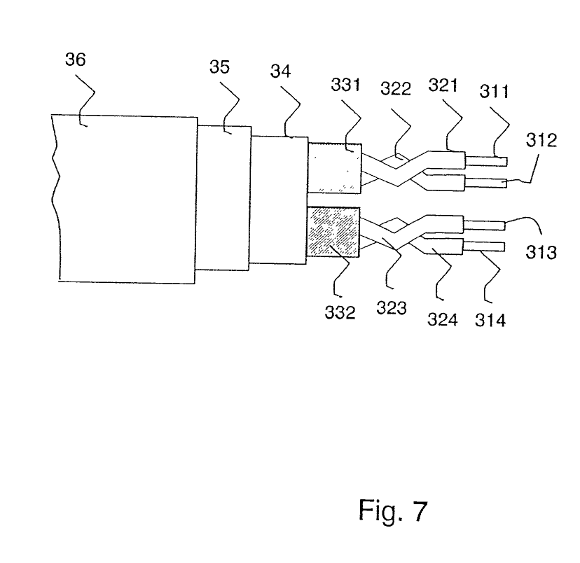

FIG. 7 illustrates the structure of a cable element including two twisted pairs, that is a first conductor pair with wires 311, 312 and a second conductor pair with wires 313, 314.

Each of the wires 311, 312, 313 and 314 has its thin insulation layer 321, 322, 323 and 324 respectively.

Each conductor pair has its absorbing layer of glass-coated microwire 331 and 332, wound on the insulated conducted pair (311, 312) and (313, 314) respectively. An optional common insulator layer 34 covers the two pairs of conductors with their magnetic absorbing layers thereon.

The lossy cable element further includes an electrical shield layer 35 and an outer protective/insulator layer 36.

More conductors and/or conductor pairs may be included in the cable, using a similar structure and method of manufacture thereof. The structure achieves good magnetic field isolation between the conductor pairs, because of the separate magnetic shielding of each pair.

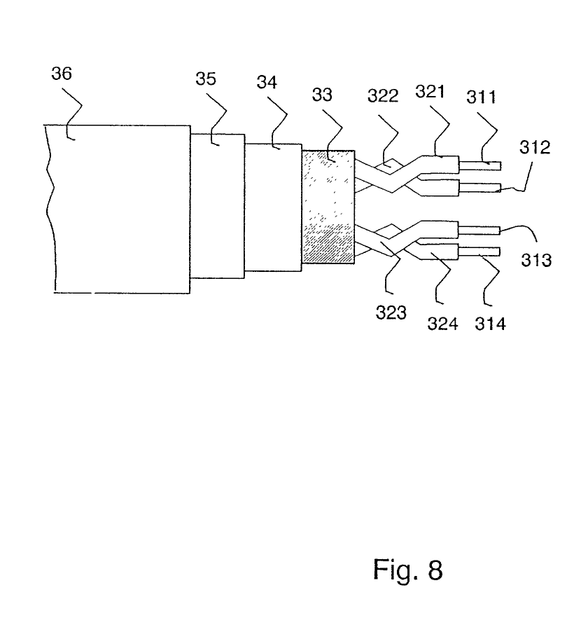

FIG. 8 illustrates another embodiment of a lossy cable element, wherein the cable includes two conductor pairs, a first conductor pair with wires 311, 312 and a second conductor pair with wires 313, 314. Each of the wires 311, 312, 313 and 314 has its thin insulation layer 321, 322, 323 and 324 respectively.

In this structure, a common layer of glass-coated microwire 33 is wound on the two conductor pairs.

A common thin insulator layer 34 covers the two pairs of conductors with absorbing magnetic layer thereon.

The lossy cable element further includes an electrical shield layer 35 and an outer protective/insulator layer 36.

More conductors and/or conductor pairs may be included in the cable, using a similar structure and method of manufacture thereof.

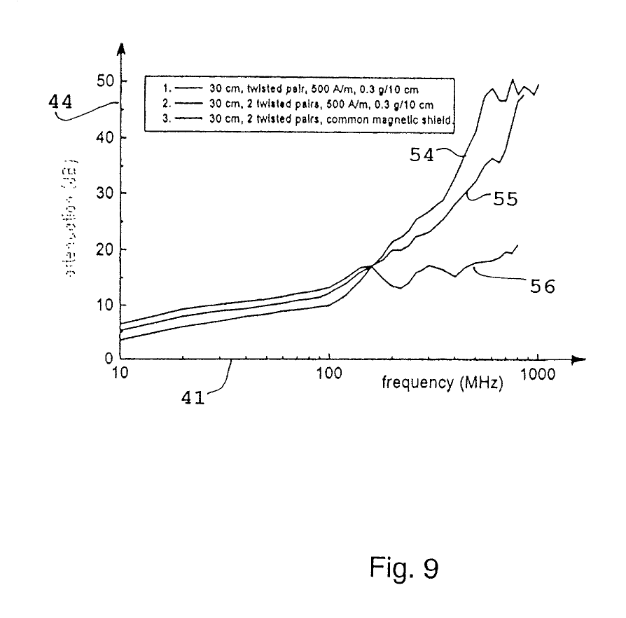

FIG. 9 details the attenuation in a filtered cable element as a function of frequency, in a graph with frequency axis 41 and attenuation axis 44. The three graphs relate each to a sample of cable elements, with a magnetic layer (microwire) of 0.3 gram/10 cm.

The graph 54 illustrates the attenuation function for one twisted pair, as illustrated in FIG. 6.

The graph 55 illustrates the attenuation function for two twisted pairs, as illustrated in FIG. 7.

The graph 56 illustrates the attenuation function for two twisted pairs having a common magnetic shield, as illustrated in FIG. 8.

It will be recognized that the foregoing is but one example of an apparatus and method within the scope of the present invention and that various modifications will occur to those skilled in the art upon reading the disclosure set forth herein before.

What is claimed is:

1. A filter for wires and cables comprising at least one pair of inner insulated wires made of an electrically conductive metal, said at least one pair of wires being covered with an outer layer of magnetic material, wherein said outer layer is formed from at least one glass-coated microwire wound around said at least one pair of wires, said at least one microwire including a soft ferromagnetic metallic alloy.

2. The filter according to claim 1, wherein said microwire is wound about said at least one pair of wires to form a thin ferromagnetic layer.

3. The filter according to claim 1, wherein said soft ferromagnetic metallic alloy is an electromagnetic energy absorbing ferromagnetic metal alloy.

4. The filter according to claim 1, wherein said soft ferromagnetic metallic alloy includes at least one selected from the group: an amorphous alloy, a nano-crystalline alloy, and; a micro-crystalline alloy.

5. The filter according to claim 1, wherein said soft ferromagnetic metallic alloy includes a (CoMe)Bsi alloy, where Me is at least one metal selected from the set of Fe, Mn, Ni and Cr.

6. The filter according to claim 1, further comprising a layer of a insulative material deployed externally with respect to said layer of magnetic material.

7. The filter according to claim 1, further comprising a layer of electrically conductive shielding material deployed externally with respect to said layer of magnetic material.

8. The filter according to claim 7, further comprising an outer insulating layer deployed externally with respect to said layer of electrically conductive shielding material.

9. The filter according to claim 1, wherein said microwire has a total thickness of between 10 and 14 microns.

10. The filter according to claim 1, wherein said microwire is wound to form a cylindrical winding in which an extensional direction of said microwire at any point is substantially perpendicular to an extensional direction of said at least one inner pair of wires.

11. The filter according to claim 1, wherein said microwire is wound to form a cylindrical winding including between 2 and 10 layers of microwire.

12. The filter according to claim 1, wherein said microwire is wound to form a cylindrical winding of overall thickness between 20 and 100 microns.

13. The filter according to claim 1, wherein said at least one pair of conductive wires is implemented as a twisted pair of conductive wires.

14. The filter according to claim 1, wherein said at least one pair of conductive wires is implemented as at least two pairs of conductive wires.

15. The filter according to claim 14, wherein said outer layer encompasses all of said at least two pairs of wires.

16. The filter according to claim 14, wherein said outer layer encompasses only one of said at least two pairs of wires, the filter further comprising a second outer layer of magnetic material, formed from at least one glass-coated microwire, wound around a second of said at least two pairs of insulated wires.

17. The filter according to claim 14, further comprising a layer of a insulative material deployed externally with respect to said layer of magnetic material.

18. The filter according to claim 14, further comprising a layer of electrically conductive shielding material deployed externally with respect to said layer of magnetic material.

19. The filter according to claim 18, further comprising an outer insulating layer deployed externally with respect to said layer of electrically conductive shielding material.
